(19) United States
(12) Patent Application Publication
(10) Pub. No.: US 2010/0287765 A1
(43) Pub. Date: Nov. 18, 2010

(54) CRIMPER CABLE RETAINER

(76) Inventor: Michael Stephens, Glen Allen, VA (US)

Correspondence Address: Thomas, Raring, & Teague, P.C., 536 GRANITE AVENUE, RICHMOND, VA, 23226, US

(21) Appl. No.: 12/778,493

(22) Filed: May 12, 2010

Related U.S. Application Data
(60) Provisional application No. 61/177,327, filed on May 12, 2009.

(51) Int. Cl. H01R 43/042

(52) U.S. Cl. 29/751

(57) ABSTRACT

A cable crimper comprises one or more handles, a crimping element affixed to the one or more handles, and a cable securing element. The cable securing element comprises a platform affixed to the crimping element and two grasping prongs slidably affixed to the platform such that the grasping prongs move together and apart along a line orthogonal to a dividing line between the two grasping prongs. Each grasping prong may comprise a slot for receiving a corresponding pin affixed to the platform, with each slot having a longitudinal axis that is orthogonal to the dividing line between the two grasping prongs.

### CROSS-REFERENCE TO RELATED APPLICATIONS

This application claims priority to provisional U.S. Application No. 61/177,327; filed May 12, 2009, the contents of which are incorporated herein by reference in their entirety.

### FIELD OF THE INVENTION

This invention relates generally to a hand tool for terminating a cable.

### BACKGROUND OF THE INVENTION

As part of any compression-style crimper used for terminating a coaxial cable with a compression connector, a necessary function is to hold the cable in place during the crimping process and preferably in-line with the axial compression of the tool. This is ordinarily done with either a fixed semi-circular, U-shaped holder, or two pincer-shaped, spring-loaded prongs.

The spring-loaded prongs offer an advantage over fixed holders as it adapts to nominal variations of cable diameters and holds the cable more securely. In such embodiments, each spring-loaded prong is secured by means of a fixed pivot made by a fixed pin through a circular hole in the prong. Each prong has tension applied inward towards the opposing prong. The shape of the inside portion of each prong allows for the insertion and removal of the cable as well as holding it in place during the crimping process. FIG. 1 illustrates a prior art arrangement for holding a cable during crimping that comprises two grasping prongs 10a, 10b. Each grasping prong is pivotally fixed to a mounting platform (not illustrated) or some other arrangement for securing the grasping prongs to the crimping tool. The grasping prongs are pivotally affixed to the mounting platform (or other arrangement) using a respective mounting pin 12a, 12b inserted through a corresponding hole defined in the lower, outer corner of each prong. Each prong has a semi-circular recess defined in the surface adjacent the other prong, such that a generally circular cable-securing void 14 is created. The prongs are biased toward each other, typically using a respective spring (not illustrated) attached to the side of each prong opposite the semi-circular recess. Each grasping prong has an inner sloped edge, such that the inner sloped edges of the two grasping prongs together form a generally V-shaped channel 16 for guiding the cable into the cable-securing void. As a user pushes a cable into the V-shaped channel 16, the prongs pivot apart until the cable enters the cable-securing void 14 at which point the springs cause the prongs to close around the cable.

The prior art arrangements, including the arrangement of FIG. 1, work well for cables that fall within nominal variations of standard diameters. However, there are common “non-standard” diameter cables that differ beyond the nominal tolerances, both larger and smaller. Different sized cables can cause a problem for conventional spring-loaded prongs, such as that of FIG. 1, because the pivot point of each prong is fixed. The fixed pivot points cause the prongs to traverse a greater arc for larger cables than for smaller cables. The result is different center positions for each size cable which can adversely affect the termination during compression. This is readily seen in FIG. 2, in which the prior art arrangement of FIG. 1 is illustrated in two different positions. The prongs 10a, 10b illustrated in solid lines in FIG. 2 show a typical position of the prongs when securing a relatively small diameter cable, while the prongs illustrated in dashed lines show a typical position of the prongs when securing a relatively large diameter cable. As seen in FIG. 2, the two different positions of the prongs result in two different center points (the center point of the solid line prongs is illustrated by the solid line cross in FIG. 2, while the center point of the dashed line prongs is illustrated by the dashed line cross) of the cable-securing void. These two different center positions of the cable-securing void would mean that two different sized cables would be held in two different positions such that the center of the cables would not always line up with the crimping mechanism during compression.

To accommodate such non-standard cables and avoid the aforementioned centering discrepancy, some tool manufacturers have provided two sets of spring-loaded prongs—one sized for larger cables and one for smaller cables, with each set placed with their respective centers in the line of compression. Such a solution is illustrated in FIGS. 3 and 4. FIG. 3 illustrates a perspective view of two such sets of prongs, while FIG. 4 illustrates a side-by-side view. In FIGS. 3 and 4, one set of prongs 20a, 20b has a relatively smaller cable-securing void 22, while the other set of prongs 24a, 24b has a relatively larger cable-securing void 26. This solution is more costly for the manufacturers and can be cumbersome for the user to insert and remove cables.

### BRIEF SUMMARY OF THE INVENTION

In one embodiment, a cable crimper comprises one or more handles, a crimping element affixed to the one or more handles, and a cable securing element. The cable securing element comprises a platform affixed to the crimping element and two grasping prongs slidably affixed to the platform such that the grasping prongs move together and apart along a line orthogonal to a dividing line between the two grasping prongs.

Each grasping prong may comprise a slot for receiving a corresponding pin affixed to the platform, each slot having a longitudinal axis that is orthogonal to the dividing line between the two grasping prongs.

Each grasping prong may define a semi-circular recess, one semi-circular recess being adjacent the other semi-circular recess, the semi-circular recesses together defining a cable-securing void.

The crimping element may comprise a compression element, and the center of the cable-securing void is substantially aligned with a center of the compression element regardless of a diameter of a cable being secured in the cable-securing void.

Each grasping prong may comprise an inner sloped edge, such that the inner sloped edges of the two grasping prongs together form a generally V-shaped channel for guiding the cable into the cable-securing void.

The cable crimper may comprise two springs, each spring adapted to bias a respective grasping prong inwardly toward the other grasping prong.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1-4 illustrate known cable-securing mechanisms for cable crimping devices;

FIG. 5 illustrates a side view of a cable crimping device, in accordance with embodiments of the present invention;

FIGS. 6, 7 and 8 illustrate perspective, side, and cross-sectional views, respectively, of a cable-securing mechanism of the crimping device of FIG. 5, in accordance with embodiments of the present invention; and

FIG. 9 illustrates two different positions of the grasping prongs of the cable-securing mechanism of FIGS. 6-8.

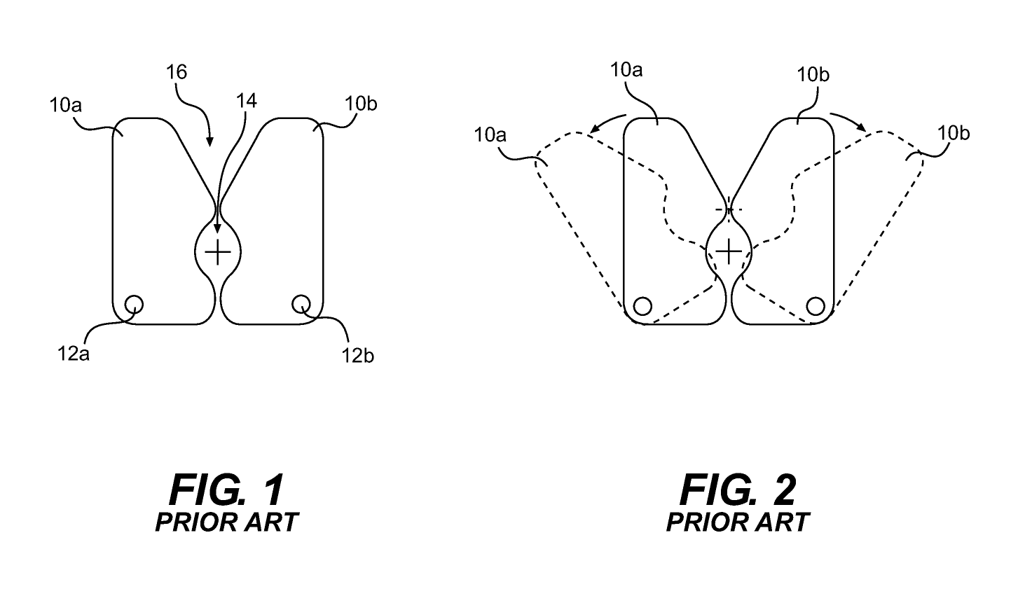

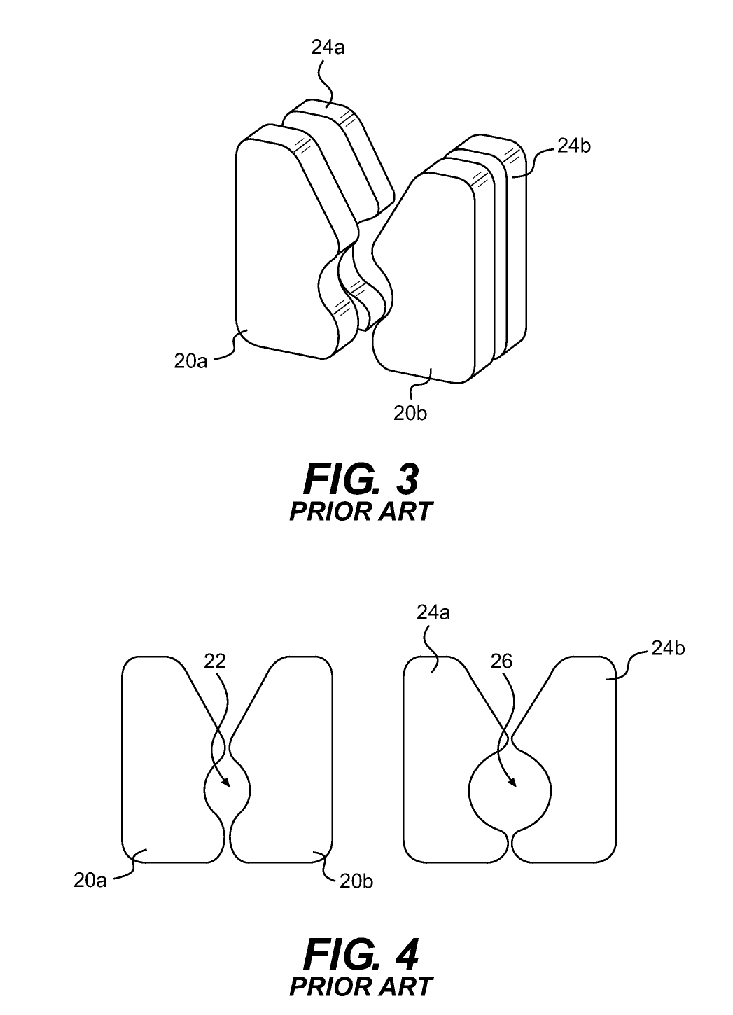

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

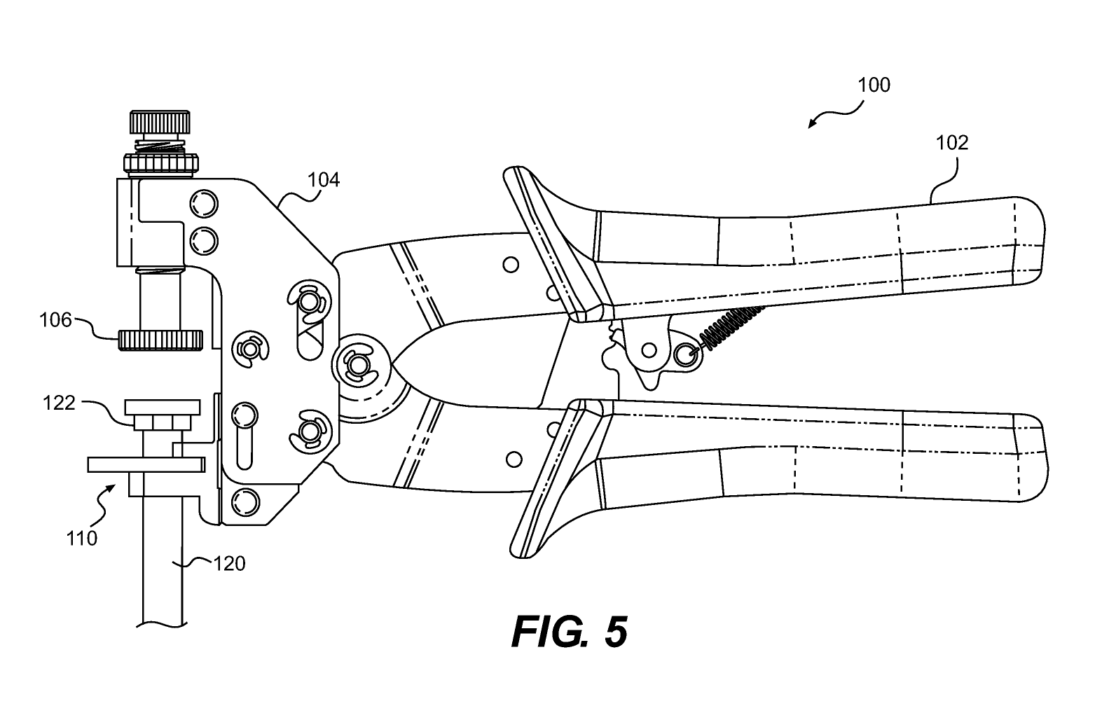

Referring now to FIG. 5, a cable crimping device is illustrated in accordance with embodiments of the invention. The cable crimping device 100 of FIG. 5 comprises a novel cable-securing mechanism that is capable of securing cables of different diameters while maintaining the centers of the different-sized cables in alignment with the crimping mechanism.

The cable crimping device 100 of FIG. 5 comprises handles 102 and a crimping head 104. The crimping head 104 comprises a compression element 106 and a novel cable securing mechanism 110. The cable securing mechanism 110 holds (in a manner described in detail below) a cable 120 (e.g., a coaxial cable) in position while the compression element 106 compresses a compression-type connector 122 onto the cable. Operating the handles causes the application of a compressing force by the compression element 106, such as by (1) moving the compression element toward the securing mechanism, (2) moving the securing mechanism toward the compression element, or (3) moving the compression element and the securing mechanism toward each other. The mechanism by which the movement of the handles is translated into movement of the compression element, the securing mechanism, or both, is beyond the scope of this application and in any event may comprise any suitable mechanism. As noted above, it is important that the center of the compression element be generally aligned with the center of the cable and connector to ensure that even compression force is applied. The compression element and the securing mechanism may be affixed to the crimping device by any suitable means.

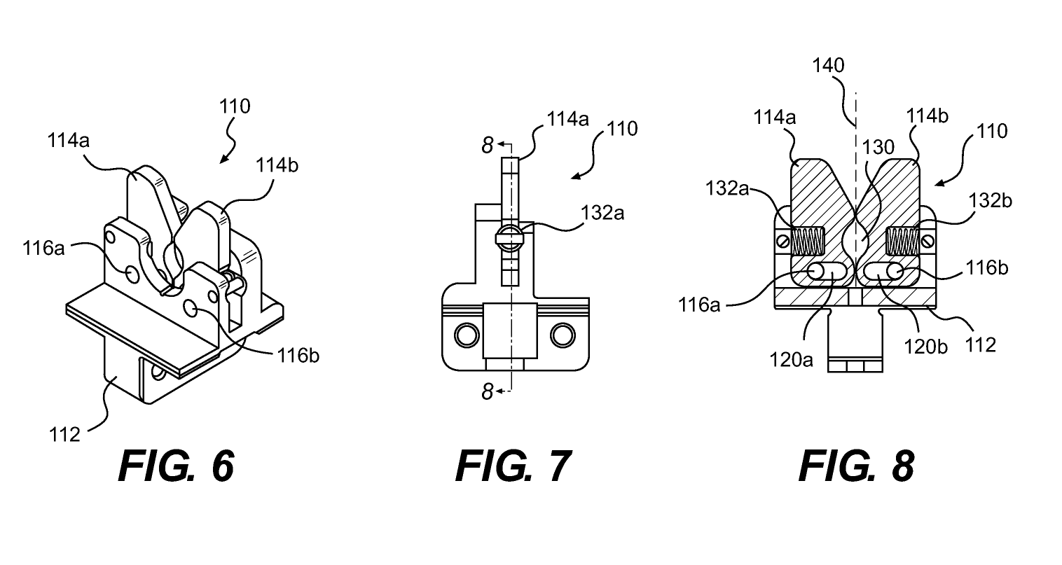

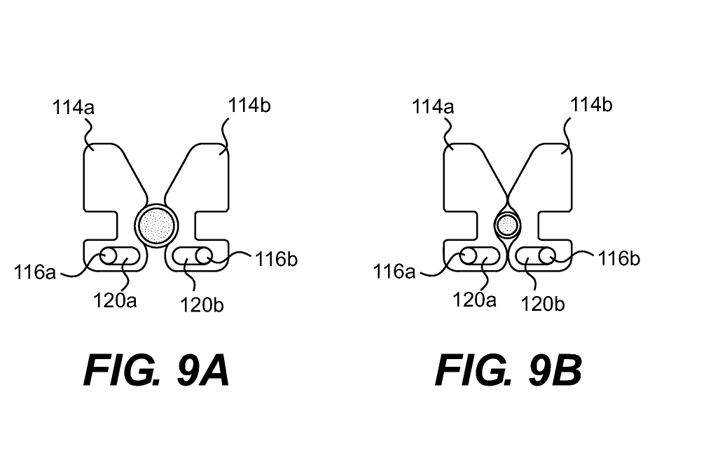

FIGS. 6, 7 and 8 illustrate perspective, side, and cross-sectional views, respectively, of a cable-securing mechanism 110 of the crimping device 100 of FIG. 5. The cable securing mechanism comprises a platform 112 and two grasping prongs 114a, 114b slidably affixed to the platform (this slidable affixation is best seen in FIGS. 8 and 9). This slidable affixation enables the grasping prongs to move together and apart along a line orthogonal to a dividing line 140 between the two grasping prongs, as seen in FIG. 9.

Each grasping prong defines a semi-circular recess adjacent the semi-circular recess of the other grasping prong, such that the semi-circular recesses together defining a cable-securing void 130.

Each grasping prong 114a, 114b comprises a slot 120a, 120b for receiving a corresponding pin 116a, 116b affixed to the platform 112. Each slot has a longitudinal axis that is orthogonal to the dividing line between the two grasping prongs. The elongated slot, in cooperation with the pin, enables the respective grasping prong to move toward and away from the other grasping prong in the desired linear arrangement. As seen and described in FIG. 9, this linear movement, which is orthogonal to the dividing line 140, ensures that the center of the cable-securing void 130 is maintained in substantial alignment with the compression head to ensure proper compression of the connector 122 regardless of the diameter of the cable being secured in the cable-securing void. Advantageously, the pins also allow the grasping prongs to pivot open (in a similar manner to the prior art grasping prongs) to facilitate the inserting and removing of the cable from the holder.

As seen in FIGS. 6, 8 and 9, each grasping prong comprises an inner sloped edge. The inner sloped edges of the two grasping prongs together form a generally V-shaped channel for guiding the cable into the cable-securing void. The cable-securing mechanism 110 further comprises two springs 132a, 132b for biasing a respective grasping prong inwardly toward the other grasping prong.

FIGS. 9A and 9B illustrate the two grasping prongs of the cable-securing mechanism 110 securing two different sized cables. FIG. 9A illustrates the two grasping prongs 114a, 114b securing a relatively large diameter cable, such that the prongs are further apart than in FIG. 9B to accommodate the relatively large cable. FIG. 9B illustrates the two grasping prongs 114a, 114b securing a relatively small diameter cable, such that the prongs are closer together than in FIG. 9A to accommodate the relatively small cable.

Embodiments of the invention enable one set of prongs to equally secure standard, large, and small cables within the same configuration. The slots allow the prongs to conform to different sized cables in a linear fashion, as opposed to in radial fashion, thereby maintaining the center position of the cable. At the same time, the pins allow the prongs to pivot open to facilitate the inserting and removing of the cable from the holder.

While embodiments of the invention are described herein in conjunction with compression-style crimpers, embodiments of the invention are not limited to such tools. Embodiments of the invention may be used with any tool in which a cable or wire needs to be held in position and in alignment with another portion of the tool.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cable crimper comprising:
one or more handles;
a crimping element affixed to the one or more handles; and
a cable securing element comprising:
a platform affixed to the crimping element; and
two grasping prongs slidably affixed to the platform such that the grasping prongs move together and apart along a line orthogonal to a dividing line between the two grasping prongs.

2. The cable crimper of claim 1, wherein each grasping prong comprises a slot for receiving a corresponding pin affixed to the platform, each slot having a longitudinal axis that is orthogonal to the dividing line between the two grasping prongs.

3. The cable crimper of claim 1, wherein each grasping prong defines a semi-circular recess, one semi-circular recess being adjacent the other semi-circular recess, the semi-circular recesses together defining a cable-securing void.

4. The cable crimper of claim 3, wherein the crimping element comprises a compression element, and wherein a center of the cable-securing void is substantially aligned with a center of the compression element regardless of a diameter of a cable being secured in the cable-securing void.

5. The cable crimper of claim 3, wherein each grasping prong comprises an inner sloped edge, such that the inner sloped edges of the two grasping prongs together form a generally V-shaped channel for guiding the cable into the cable-securing void.

6. The cable crimper of claim 1, further comprising two springs, each spring adapted to bias a respective grasping prong inwardly toward the other grasping prong.

7. A cable crimper comprising:
handle means;
crimping means affixed to the handle means; and
cable securing means comprising:
mounting means affixed to the crimping element; and
two grasping prongs slidably affixed to the mounting means such that the grasping prongs move together and apart along a line orthogonal to a dividing line between the two grasping prongs.

8. The cable crimper of claim 7, wherein each grasping prong comprises a slot for receiving a corresponding pin affixed to the mounting means, each slot having a longitudinal axis that is orthogonal to the dividing line between the two grasping prongs.

9. The cable crimper of claim 7, wherein each grasping prong defines a semi-circular recess, one semi-circular recess being adjacent the other semi-circular recess, the semi-circular recesses together defining a cable-securing void.

10. The cable crimper of claim 9, wherein the crimping means comprises a compression element, and wherein a center of the cable-securing void is substantially aligned with a center of the compression element regardless of a diameter of a cable being secured in the cable-securing void.

11. The cable crimper of claim 9, wherein each grasping prong comprises an inner sloped edge, such that the inner sloped edges of the two grasping prongs together form a generally V-shaped channel for guiding the cable into the cable-securing void.

12. The cable crimper of claim 7, further comprising biasing means adapted to bias each grasping prong inwardly toward the other grasping prong.

13. A workpiece-securing fixture comprising:
a platform; and
two grasping prongs slidably affixed to the platform such that the grasping prongs move together and apart along a line orthogonal to a dividing line between the two grasping prongs.

14. The fixture of claim 13, wherein each grasping prong comprises a slot for receiving a corresponding pin affixed to the platform, each slot having a longitudinal axis that is orthogonal to the dividing line between the two grasping prongs.

15. The fixture of claim 13, wherein each grasping prong defines a semi-circular recess, one semi-circular recess being adjacent the other semi-circular recess, the semi-circular recesses together defining a cable-securing void.

16. The fixture of claim 15, wherein each grasping prong comprises an inner sloped edge, such that the inner sloped edges of the two grasping prongs together form a generally V-shaped channel for guiding the cable into the cable-securing void.

17. The fixture of claim 13, further comprising two springs, each spring adapted to bias a respective grasping prong inwardly toward the other grasping prong.
